(19) United States
(12) Patent Application Publication
(10) Pub. No.: US 2025/0050357 A1
(43) Pub. Date: Feb. 13, 2025

(54) ADJUSTABLE WATER PRESSURE SHOWER SYSTEM

(71) Applicant: Gaetano Catanzaro, Plantation, FL (US)

(72) Inventor: Gaetano Catanzaro, Plantation, FL (US)

(21) Appl. No.: 18/527,864

(22) Filed: Dec. 4, 2023

Related U.S. Application Data
(60) Provisional application No. 63/518,367, filed on Aug. 9, 2023.

(51) Int. Cl. B05B 1/18

(52) U.S. Cl. CPC B05B 1/18

(57) ABSTRACT

A shower system is disclosed to lower water pressure for a predetermined duration such as for conserving water while the showerer/bather lathers themselves. The shower system includes a control element in the form of a turn dial or a push button. In one embodiment, the turn dial is rotatable and designed to regulate water pressure from the plurality of spray openings of the shower system for a predetermined time. The turn dial lowers the water pressure for the first time period when the dial end aligns with a first position mark. The turn dial lowers the water pressure for a second time period when the dial end aligns with a second position mark. In another embodiment, the control element is a push button. Actuation of the push button by a user lowers the water pressure of water being discharged from a plurality of spray openings for a predetermined duration.

### CROSS-REFERENCE TO RELATED APPLICATION

The present application claims priority to, and the benefit of, U.S. Provisional Application No. 63/518,367, which was filed on Aug. 9, 2023, and is incorporated herein by reference in its entirety.

### FIELD OF THE INVENTION

The present invention generally relates to the field of shower heads. More specifically, the present invention relates to a novel shower head capable of changing the water pressure emitted for a select period of time. In one embodiment, a timer dial positioned in the shower head can be rotated to select a time for reducing water pressure. In another embodiment, a push button is actuated to reduce the water pressure. Accordingly, the present disclosure makes specific reference thereto. Nonetheless, it is to be appreciated that aspects of the present invention are also equally applicable to other like applications, devices, and methods of manufacture.

### BACKGROUND

By way of background, many individuals enjoy taking long, warm showers for relaxation. The warm water helps to soothe muscles and relieve stress, making it a popular way to refresh. However, over time during a long shower, especially in homes with shared plumbing systems such as in high-rise buildings or homes with multiple showers, water pressure can decrease. Additionally, the water temperature may cool down during the shower. Insufficient water pressure can be frustrating because it affects the effectiveness of rinsing off soap and shampoo. It can also lead to longer shower times as individuals try to compensate for the reduced pressure. The mentioned issues can negatively impact the pleasurable and relaxing experience of taking a bath or shower.

Conventional shower heads generally release water at a constant water pressure. This also results in releasing water at a constant (high) pressure even when a showerer lathers. The constant release wastes water. Individuals may frequently need to stop and restart the shower to save water, which can disrupt the showering/bathing experience. Conventional shower heads do not provide easy and predetermined control over water pressure. Many individuals are looking for ways to reduce their water utility bills. Saving water not only reduces household expenses but also benefits the environment. Individuals desire an improved shower head that can provide low pressure for a desired time upon activation by a showering/bathing user.

Therefore, there exists a long-felt need in the art for an improved shower head designed to lower the water pressure emitted from the head upon activation or selection by a showering/bathing user. Additionally, there is a long-felt need in the art for an improved shower head that lowers the water pressure for a predetermined time to decrease the wastage of water during showering/bathing. Moreover, there is a long-felt need in the art for a shower head that allows showering/bathing users to adjust the water pressure easily. Further, there is a long-felt need in the art for a water pressure adjustable shower head that encourages more conscious water conservation while showering. Furthermore, there is a long-felt need in the art for a shower head that allows users to reduce water pressure without affecting the water temperature. Finally, there is a long-felt need in the art for an improved shower head that allows showerers/bathers to take longer showers without the water going cold, thus enhancing the comfort and relaxation of the showering/bathing experience.

The subject matter disclosed and claimed herein, in one embodiment thereof, comprises a multi-pressure shower system. The shower system features a housing constructed from a waterproof and lightweight material and a control element is positioned within the housing. In one embodiment, the control element is a turn dial. The turn dial is rotatable and designed to regulate water pressure from the plurality of spray openings of the shower system for a predetermined time. The turn dial lowers the water pressure for the first time period when the dial end aligns with a first position mark. The turn dial lowers the water pressure for a second time period when the dial end aligns with a second position mark. In another embodiment, the control element is a push button. Actuation of the push button by a user lowers the water pressure of water being discharged from a plurality of spray openings for a predetermined duration.

In this manner, the multi-pressure shower system of the present invention accomplishes all of the foregoing objectives and provides users with a shower head designed to lower water pressure emitted from the head to allow for lathering soap, and shampoo while showering/bathing. The shower system enables users to set a timer dial or press a button to lower the water pressure for a predetermined duration such as 15 seconds, 30 seconds, 60 seconds, 90 seconds, or any other value, saving water while the showerer/bather lathers themselves.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-pressure shower system. The shower system further comprising a housing constructed from a waterproof and lightweight material and a turn dial is positioned within the housing. The turn dial is rotatable and designed to regulate water pressure from the plurality of spray openings of the shower system for a predetermined time. The turn dial is configured to lower the water pressure for the first time period when the dial end aligns with a first position mark. The turn dial lowers the water pressure for a second time period when the dial end aligns with a second position mark. The first position mark and the second position mark are printed or embossed on the housing.

In yet another embodiment, a water adjustable shower head is disclosed. The shower head includes a housing, the housing comprising a front surface, and a handle. A plurality of spray openings is disposed on the front surface of the housing for dispensing water. A turn dial is positioned within the housing, the turn dial is rotatable and designed to regulate water pressure from the plurality of spray openings for a predetermined time. The turn dial is configured to lower the water pressure for thirty seconds when the dial end aligns with a first position mark and to lower the water pressure for sixty seconds when the dial end aligns with a second position mark. The lower water pressure is in the range of about 10% to about 30% of the standard or initial water pressure.

In a further embodiment, a multi-pressure shower head system is disclosed. The shower system includes a housing incorporated with a push button, actuation of the push button by a user lowers the water pressure of water being discharged from a plurality of spray openings for a predetermined duration. The push button remains depressed throughout the predetermined duration and wherein upon the elapse of the predetermined duration, the push button is automatically disengaged, causing an increase in the water pressure of the shower head system.

In still another embodiment of the present invention, a water pressure adjustable shower system is disclosed. The shower system includes a timer module embedded within the housing of the shower system, the timer module is configured to receive and count preconfigured timer values, the timer module initiates a counting process when a user manipulates a control element, the control element can be one of a turn dial positioned at one or more predefined positions or a push button in a pushed state. An actuator embedded within the shower head system is automatically triggered by the timer module upon initiation of the counting process. The actuator upon triggering activates one of the spray opening barriers to partially cover one or more spray openings or a valve to partially close to lower the water pressure.

In another aspect of the present invention, a smart shower head system is disclosed. The smart shower head system is wirelessly coupled to a mobile phone application, the mobile phone application allows the creation of a plurality of user profiles, wherein each user profile within the mobile phone application is associated with a specific lower water pressure timer value, enabling for personalized customization of the shower experience. A timer module integrated into the smart shower is configured to receive instructions from the mobile phone application and, upon selection of a specific user profile in the mobile application, initiates a lower water pressure for the duration associated with the selected profile.

Numerous benefits and advantages of this invention will become apparent to those skilled in the art to which it pertains upon reading and understanding the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the adjustable water pressure shower head of the present invention in accordance with the disclosed structure;

FIG. 2 illustrates a perspective view showing the opening of the spray openings of the shower head in accordance with the disclosed structure;

FIG. 3 illustrates a perspective view of another embodiment of the adjustable water pressure shower head of the present invention in accordance with the disclosed architecture;

FIG. 4 illustrates a functional block diagram showing the mechanism used for lowering the water pressure for a predetermined time of the shower head of different embodiments of the present invention in accordance with the disclosed structure;

FIG. 5 illustrates a smart shower head version of the shower head of the present invention in accordance with the disclosed structure; and

FIG. 6 illustrates another embodiment showing a position of the push button placed on the shower turn on and off valve for easy accessibility in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved shower head designed to lower the water pressure emitted from the head upon activation or selection by a showering/bathing user. Additionally, there is a long-felt need in the art for an improved shower head that lowers the water pressure for a predetermined time to decrease the wastage of water during showering/bathing. Moreover, there is a long-felt need in the art for a shower head that allows showering/bathing users to adjust the water pressure easily. Further, there is a long-felt need in the art for a water pressure adjustable shower head that encourages more conscious water conservation while showering. Furthermore, there is a long-felt need in the art for a shower head that allows users to reduce water pressure without affecting the water temperature. Finally, there is a long-felt need in the art for an improved shower head that allows showerers/bathers to take longer showers without the water going cold, thus enhancing the comfort and relaxation of the showering/bathing experience.

The present invention, in one exemplary embodiment, is a water pressure adjustable shower system. The shower system includes a timer module embedded within the housing of the shower system, the timer module is configured to receive and count preconfigured timer values, the timer module initiates a counting process when a user manipulates a control element, the control element can be one of a turn dial positioned at one or more predefined positions or a push button in a pushed state. An actuator embedded within the shower head system is automatically triggered by the timer module upon initiation of the counting process. The actuator upon triggering activates one of the spray opening barriers to partially cover one or more spray openings or a valve to partially close to lower the water pressure.

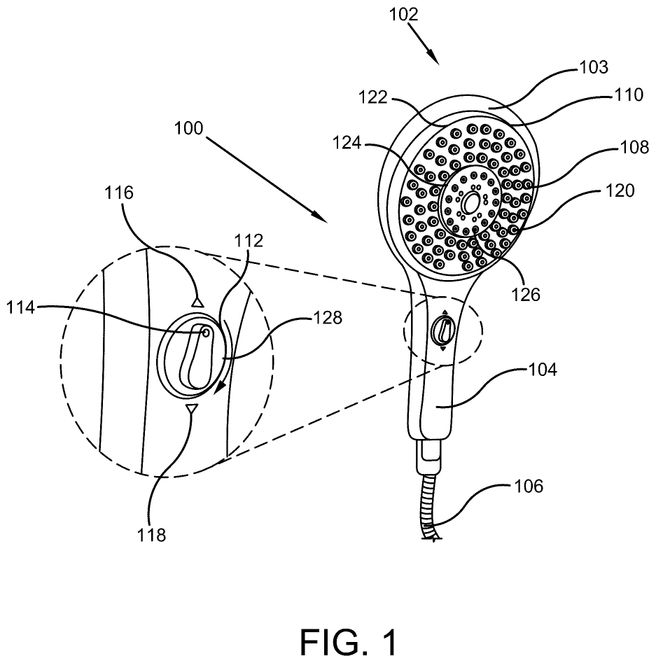

Referring initially to the drawings, FIG. 1 illustrates a perspective view of one potential embodiment of the adjustable water pressure shower head of the present invention in accordance with the disclosed structure. The adjustable water pressure shower system 100 is designed to change the water pressure of dispensing water therefrom for a predetermined time period. More specifically, the multi-pressure shower system 100 has a housing 102 made of steel, plastic, or any other waterproof and lightweight material. The housing 102 includes a shower head 103, a handle 104, and a flexible water pipe 106 attached to the handle 104. The water pipe 106 provides water from a water inlet to be dispensed from a plurality of spray openings 108 disposed on the front surface 110 of the shower head 103.

A turn dial or timer dial 112 is disposed in the housing 102 and is used for regulating or changing water pressure from the spray openings 108 for a predetermined time. The turn dial 112 functions like a knob and is designed to lower the water pressure for a first time period when the dial end 114 points to a first position mark 116. The water pressure is lowered for a second time period when the dial end 114 points to a second position mark 118. The first time period is different from the second time period and can be less or more than the second time period. In one exemplary embodiment, the first time period is 30 seconds and the second time period is 60 seconds.

The turn dial 112 can be used by a user for lowering the water pressure selectively for a time duration such as when lathering during a shower or bath. In one embodiment, the lower water pressure can be from about 10% to about 30% of the standard or initial water pressure from the shower head 100 (when the turn dial 112 does not point to positions 116, 118). In one exemplary embodiment, the lower water pressure can be from about 15% to about 25% of the standard or initial water pressure from the multi-pressure shower head 100.

In the present embodiment, when the turn dial 112 is in one of the positions 116, 118, a plurality of the spray openings (shown through numeral 120 between the section lines 122 and 124 on the front surface 110) is in a closed or clogged state whereas remaining spray openings 126 are in an open position. In some embodiments, all the spray openings 108 can be opened and release water at a common lower water pressure when the dial end 114 points to one of the positions 116, 118. The turn dial 112 is integrated into the shower head 100 during manufacturing of the shower head 100 but in some embodiments can be used as an aftermarket accessory to increase the functionality of the multi-pressure shower system 100.

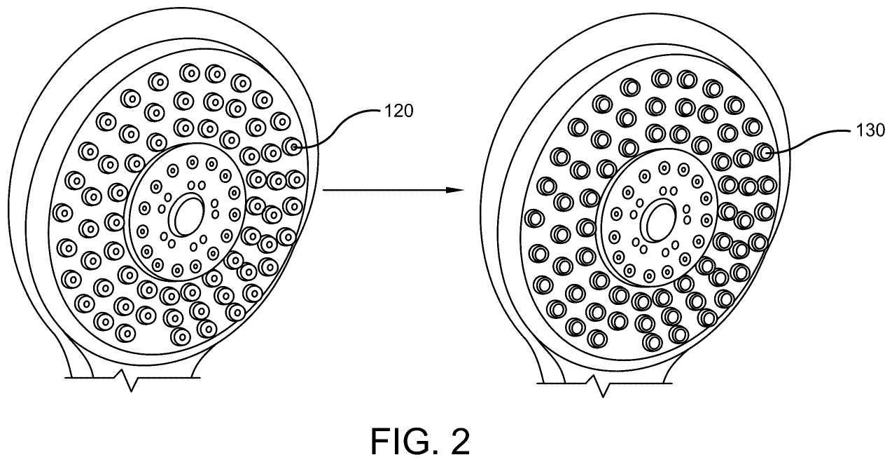

When the turn dial end 114 is turned to point to the first position 116, the water pressure is automatically lowered for the first time period and the turn dial 112 automatically turns back to point to normal or initial position 128 when the first time period is elapsed. Similarly, when the turn dial end 114 is turned to point to the second position 118, the water pressure is automatically lowered for the second time period and the turn dial 112 automatically turns back to point to normal or initial position 128 when the second time period is elapsed. When the respective time elapses, the shower head 100 starts dispensing water at a normal water pressure with all the spray openings 108 working without clogging. The closed openings 120 open automatically (shown through numeral 130) when the lower water pressure time elapses as illustrated in FIG. 2.

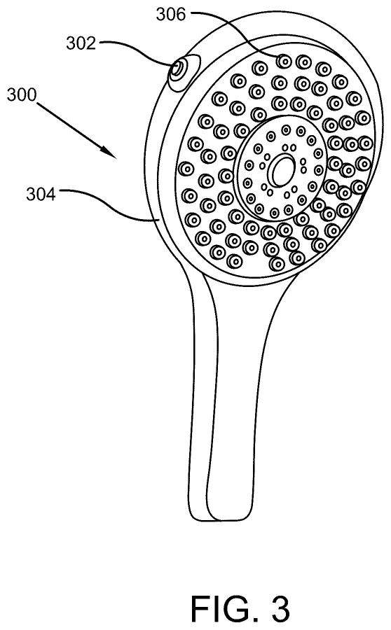

FIG. 3 illustrates a perspective view of another embodiment of the adjustable water pressure shower head of the present invention in accordance with the disclosed architecture. The shower head 300 of the present embodiment includes a push button 302 disposed on the housing 304 of the shower head 300. The push button 302, when pressed by a user, allows the shower head 300 to lower the pressure of water being released from the spray openings 306 for a predetermined time. The push button 302 remains pressed for the predetermined time and when the predetermined time is elapsed, the push button 302 is automatically released to increase the water pressure of the shower head 300.

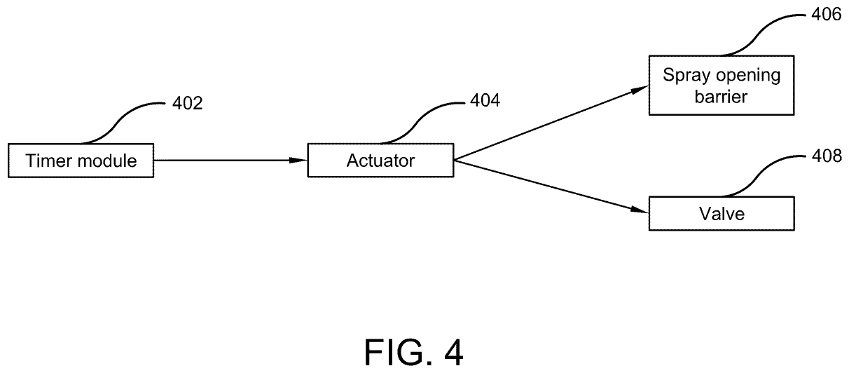

The push button 302 is integrated into the shower head 300 during manufacturing of the shower head 300 and is internally connected to an integrated timer module as illustrated in FIG. 4. A user during showering can push the button 302 as per the requirements to lower the water pressure and thus reduce water wastage in addition to improve showering/bathing experience.

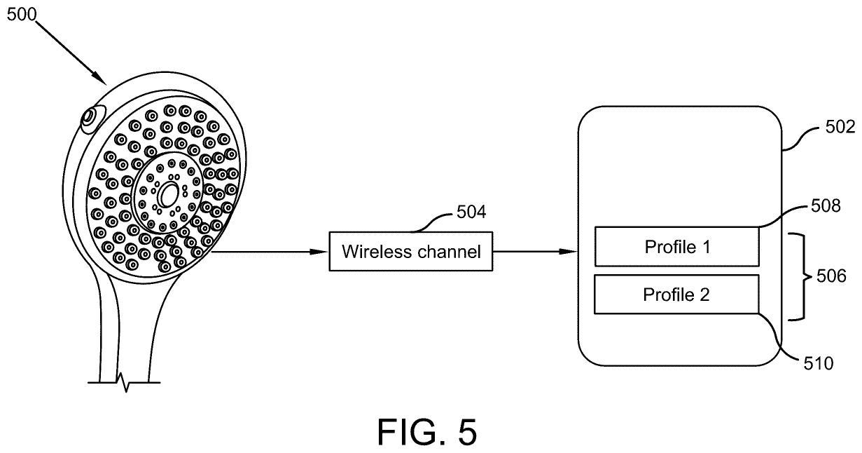

FIG. 4 illustrates a functional block diagram showing the mechanism used for lowering the water pressure for a predetermined time of the shower head of different embodiments of the present invention in accordance with the disclosed structure. The shower head (100, 300) includes a timer module 402 which can be configured to different timer values either during manufacturing of the shower head or alternatively using a mobile phone application as illustrated in FIG. 5. The timer module 402 is embedded inside the housing of the module and counts the timer value when the position of the turn dial 112 is in position 116, 118 (in FIG. 1) and when the push button 302 is in a pushed state (FIG. 3).

An actuator 404 is embedded inside the shower head and is automatically actuated when the timer module 402 starts counting the preconfigured timer value as described above. The actuator 404 can be configured to activate a spray opening barrier 406 to partially cover one or more spray openings (as described in FIG. 1) of the shower head to reduce the water pressure for the preconfigured timer value. Once the preconfigured time is elapsed, then, the spray opening barrier 406 is removed to open the spray openings to release the standard or initial water pressure from the shower head.

In some embodiments, the actuator 404 is connected to a valve 408. The valve 408 is partially closed during activation of the timer value (using the turn dial or push button) for lowering the water pressure and when the timer value is completed, the valve 408 is automatically opened for providing standard or initial water pressure through the spray openings. It will be apparent to a person skilled in the art that either one or both the spray opening barrier 406 and the valve 408 can be used in the shower heads of the present invention for customizing the water pressure.

FIG. 5 illustrates a smart shower head version of the shower head of the present invention in accordance with the disclosed structure. In the present embodiment, the smart shower head 500 can be coupled to a mobile phone application 502 using Bluetooth or any other wireless communication channel 504. A plurality of profiles 506 can be created in the application 502 and each profile can be associated with a specific lower water pressure timer value. As an example, “profile 1” 508 can be associated with 30 seconds, and “profile 2” 510 can be associated with 60 seconds as per the requirements or preferences of different users.

For personalized adjusting of water pressure from the shower head 500, a profile is selected from the application 502 and the timer module (same as of the FIG. 4) of the shower head 500 provides lower pressure for the time associated with the profile. In some embodiments, a lower pressure value can be associated with a profile for enabling users to customize the lower pressure of the water for showering.

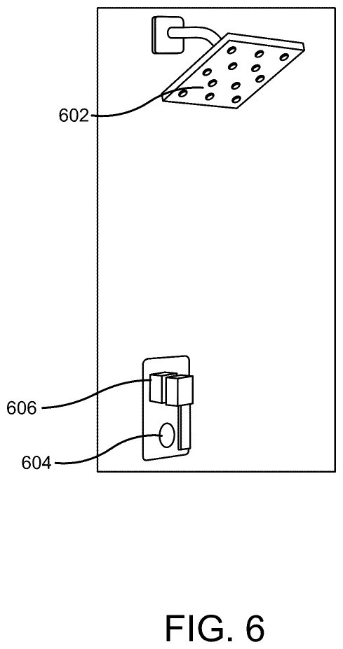

FIG. 6 illustrates another embodiment showing the position of the push button placed on the shower turn on and off valve for easy accessibility in accordance with the disclosed structure. In cases of wall-mounted showers 602, the push button 604 (or turn dial) can be positioned on the shower turn on/off valve 606 installed at a lower height than the shower 602. This allows shorter individuals and children to lower the water pressure as per their requirements easily.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-pressure shower system”, “multi-pressure shower head”, “adjustable water pressure shower head”, “adjustable water pressure shower system” and “shower head” are interchangeable and refer to the adjustable water pressure shower head 100, 300, 500 of the present invention.

Notwithstanding the foregoing, the adjustable water pressure shower head 100, 300, 500 of the present invention can be of any suitable size and configuration as is known in the art without affecting the overall concept of the invention, provided that it accomplishes the above-stated objectives. One of ordinary skill in the art will appreciate that the adjustable water pressure shower head 100, 300, 500 as shown in the FIGS. 1-6 are for illustrative purposes only, and that many other sizes and shapes of the adjustable water pressure shower head 100, 300, 500 are well within the scope of the present disclosure. Although the dimensions of the adjustable water pressure shower head 100, 300, 500 are important design parameters for user convenience, the adjustable water pressure shower head 100, 300, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-pressure shower system comprising:
a housing including a handle, a flexible water pipe attached to said handle, a shower head, and a timer dial;
wherein said water pipe connected to a water inlet for supplying water to said handle;
wherein said shower head having a plurality of spray openings disposed on a front surface of said housing;
wherein said timer dial having selectively at least a first position and a second position;
wherein said first position lowers an initial water pressure to a first water pressure for a first predetermined period of time when said timer dial is moved from an initial position to said first position;
wherein said second position lowers said initial water pressure to said first water pressure for a second predetermined period of time when said timer dial is moved from said initial position to said second position; and
further wherein said first water pressure is from 10% to 30% of said initial water pressure.

2. The multi-pressure shower system of claim 1, wherein said first water pressure is from 15% to 25% of said initial water pressure.

3. The multi-pressure shower system of claim 1, wherein said second predetermined period of time is greater than said first predetermined period of time.

4. The multi-pressure shower system of claim 3, wherein said first predetermined period of time is 30 seconds and said second predetermined period of time is 60 seconds.

5. The multi-pressure shower system of claim 3, wherein said housing is waterproof.

6. The multi-pressure shower system of claim 1, wherein said first position closing off a selected number of said plurality of spray openings.

7. The multi-pressure shower system of claim 1, wherein said timer dial automatically returning to said initial position and said initial water pressure after said first predetermined period of time elapses.

8. The multi-pressure shower system of claim 7, wherein said timer dial automatically returning to said initial position and said initial water pressure after said second predetermined period of time elapses.

9. A multi-pressure shower system comprising:
a housing including a shower head, and a timer dial;
wherein said shower head connected to a water inlet for supplying water to said shower head;
wherein said shower head having a plurality of spray openings disposed on a front surface of said housing;
wherein said timer dial having selectively at least a first position and a second position;
wherein said first position lowers an initial water pressure to a first water pressure for a first predetermined period of time when said timer dial is moved from an initial position to said first position; and
further wherein said first water pressure is from 10% to 30% of said initial water pressure.

10. The multi-pressure shower system of claim 9, wherein said second position lowers said initial water pressure to said first water pressure for a second predetermined period of time when said timer dial is moved from said initial position to said second position.

11. The multi-pressure shower system of claim 10, wherein said second predetermined period of time is greater than said first predetermined period of time.

12. The multi-pressure shower system of claim 11, wherein said first position closing off a selected number of said plurality of spray openings.

13. The multi-pressure shower system of claim 12, wherein said timer dial automatically returning to said initial position and said initial water pressure after said first predetermined period of time elapses.

14. The multi-pressure shower system of claim 12, wherein said timer dial automatically returning to said initial position and said initial water pressure after said second predetermined period of time elapses.

15. A multi-pressure shower system comprising:
a housing including a shower head, and a timer dial;
wherein said shower head connected to a water inlet for supplying water to said shower head;
wherein said shower head having a plurality of spray openings disposed on a front surface of said housing;
wherein said timer dial having selectively at least a first position and a second position;
wherein said first position lowers an initial water pressure to a first water pressure for a first predetermined period of time when said timer dial is moved from an initial position to said first position;
wherein said second position lowers said initial water pressure to said first water pressure for a second predetermined period of time when said timer dial is moved from said initial position to said second position; and
further wherein said timer dial automatically returning to said initial position and said initial water pressure after said first predetermined period of time elapses.

16. The multi-pressure shower system of claim 15, wherein said first water pressure is from 10% to 30% of said initial water pressure.

17. The multi-pressure shower system of claim 15, wherein said first water pressure is from 15% to 25% of said initial water pressure.

18. The multi-pressure shower system of claim 15, wherein said second predetermined period of time is greater than said first predetermined period of time.

19. The multi-pressure shower system of claim 15, wherein said first position closing off a selected number of said plurality of spray openings.

20. The multi-pressure shower system of claim 15, wherein said timer dial automatically returning to said initial position and said initial water pressure after said second predetermined period of time elapses.
